(19) United States
(12) Patent Application Publication
(10) Pub. No.: US 2011/0133356 A1
(43) Pub. Date: Jun. 9, 2011

(54) METHOD FOR MANUFACTURING MOLDED BODIES FROM SILICONE RUBBER

(75) Inventors: Johann Schuster, Emmerting (DE); Thomas Frese, Burghausen (DE); Reinhard Rothenaicher, Neuoetting (DE)

(73) Assignee: WACKER CHEMIE AG, Munich (DE)

(21) Appl. No.: 13/056,701

(22) PCT Filed: Jul. 28, 2009
(86) PCT No.: PCT/EP2009/059741

§ 371 Date: Jan. 31, 2011

(30) Foreign Application Priority Data
Aug. 8, 2008 (DE) 10 2008 041 121.3

(51) Int. Cl. C08L 83/04; B29C 71/02

(52) U.S. Cl. 264/82; 264/236

(57) ABSTRACT

Silicone moldings are conditioned in a conditioning oven at a pressure less than 150 hPa, and exhaust gas from the oven is scrubbed with cold water from which an organic phase is separated. The cold water is recirculated, and the scrubbed exhaust gas may be recirculated. Emissions of volatiles by this method are sharply reduced.

The present invention relates to a process for producing moldings made of silicone rubber via crosslinking and then conditioning.

The production of silicone rubber items made of crosslinkable siloxane compositions has been known for a long time, and various crosslinking systems and starting materials are available here. Silicone rubber items are produced via crosslinking of the corresponding silicone compositions. After said crosslinking, it is advantageous for many applications to heat-treat the resultant moldings, i.e. to condition them, in order to remove undesired volatile substances, e.g. cyclic siloxanes. The conditioning of silicone rubbers, especially of the addition-crosslinkable systems, generally takes place in the presence of air or oxygen, since reactions with oxygen take place during the conditioning process. Reference may be made here by way of example to DE-A 19634971. The conditioning process generally takes place over a number of hours at temperatures around 200° C. and at atmospheric pressure. There is often a resultant problem related to safety and to emissions, caused by evolution of gases composed of volatile compounds. Operations use high air throughputs through the oven in order to make the process safe and to avoid occurrence of ignitable mixtures, but this firstly requires increased energy consumption and secondly dilutes volatile constituents to an extent that makes scrubbing of the exhaust gas almost impossible. A consequence of this in turn is that industrial-scale processes often find it difficult to comply with threshold values for concentrations in air.

The invention provides a process for producing moldings made of silicone rubber via crosslinking of compositions based on organosilicon compounds and then conditioning of the resultant moldings, characterized in that the conditioning is carried out at a pressure smaller than 150 hPa.

The compositions used in the invention can be any desired previously known types of compositions which can be crosslinked to give elastomers and which are based on organosilicon compounds, examples being single-component or two-component organopolysiloxane compositions which can be vulcanized at room temperature (“RTV compositions”) or at elevated temperature (“LSR compositions or HTV compositions”), where the crosslinking process can take place via condensation, an addition reaction of Si-bonded hydrogen onto an aliphatic multiple bond, or via radiation, or peroxidically via formation of free radicals. The crosslinkable compositions here can be free from fillers, but can also comprise active or inert fillers.

The nature and amount of components usually used in these compositions are known. Reference may be made here by way of example to U.S. Pat. No. 5,268,441, DE-A 44 01 606, DE-A 44 05 245, and DE-A 43 36 345.

It is preferable that the compositions used in the invention are compositions that can be crosslinked via an addition reaction, compositions that can be crosslinked peroxidically, and compositions that can be crosslinked by radiation.

The compositions used in the invention can be crosslinked (vulcanized) by a previously known method. Production processes that can be applied here are any of the familiar processes for the processing of silicone rubbers. Examples of these are calendering, compression molding, injection molding, extrusion, and casting.

The moldings produced in the invention here can be any desired moldings, examples being profiles, hoses, pacifiers, spark-plug terminals, coatings, and silicone cables.

The moldings obtained via crosslinking are conditioned in the process of the invention. Said conditioning preferably takes place directly after the crosslinking step in a conditioning oven. The end of the crosslinking step is known to the person skilled in the art and is generally defined via the respective process; in the case of injection molding, for example, it is directly after ejection from the mold, and in the case of extrusion it is after the material leaves the heating tunnel. The degree of crosslinking at the end of the crosslinking step is preferably from 90 to 97%. The conditioning step of the invention can then increase the degree of crosslinking up to 100%.

The conditioning of the invention is preferably carried out at a pressure of from 10 to 150 hPa, particularly preferably from 50 to 100 hPa.

The conditioning of the invention is preferably carried out at a temperature of from 20 to 350° C., particularly at from 50 to 250° C., in particular at from 150 to 200° C.

Particularly when the compositions used are capable of addition-crosslinking, it is preferable that the conditioning of the invention is carried out in the presence of oxygen, in particular atmospheric oxygen. The conditioning times in the process of the invention are preferably from 0.5 to 6 hours, particularly from 2 to 4 hours.

It is preferable that the degree of crosslinking of the moldings produced in the invention is from 95 to 100%, particularly about 97%. The degree of crosslinking depends primarily on the conditioning conditions selected. The intended degree of crosslinking in the process of the invention depends primarily on the use of the molding, and also on economic factors.

In one preferred embodiment of the process of the invention, compositions based on organosilicon compounds selected from compositions crosslinkable via an addition reaction, peroxidically crosslinkable compositions, and also radiation-crosslinkable compositions, are allowed to crosslink, and the resultant moldings are then conditioned at a pressure smaller than 150 hPa and at a temperature of from 20 to 350° C.

If the compositions used in the process of the invention involve addition-crosslinkable compositions, preference is given to those comprising
(1) organosilicon compounds which have SiC-bonded moieties having aliphatic multiple carbon-carbon bonds,
(2) organosilicon compounds having Si-bonded hydrogen atoms, or, instead of (1) and (2),
(3) organosilicon compounds which have SiC-bonded moieties having aliphatic multiple carbon-carbon bonds and having Si-bonded hydrogen atoms,
(4) a catalyst promoting the addition reaction of Si-bonded hydrogen onto an aliphatic multiple bond, and, if appropriate,
(5) further substances.

The compositions that are used in the process of the invention and that can be crosslinked via an addition reaction of Si-bonded hydrogen onto an aliphatic multiple bond can be allowed to crosslink under conditions identical with those used for the previously known compositions that can be crosslinked via a hydrosilylation reaction. Preferred temperatures here are from 100 to 220° C., particularly from 130 to 190° C., and a preferred pressure here is from 900 to 1100 hPa.

If the compositions used in the process of the invention involve peroxidically crosslinkable compositions, preference is given to those comprising
(A) organosiloxanes,
(B) an agent that brings about crosslinking by way of free radicals,
   and, if appropriate,
(C) further substances.

The peroxidically crosslinkable compositions used in the invention can be allowed to crosslink under conditions identical with those used for the peroxidically crosslinkable compositions known hitherto, preferably at from 150 to 300° C. and at the pressure of the surrounding atmosphere, i.e. at about from 900 to 1100 hPa. However, it is also possible to use pressures up to 40 000 hPa.

If the compositions used in the process of the invention are radiation-crosslinkable compositions, preference is given to those comprising
(i) organopolysiloxanes having acrylate and/or having vinyl groups, and,
   if appropriate,
(ii) at least one crosslinking agent,
(iii) one photopolymerization initiator, and,
   if appropriate,
(iv) polymerization inhibitors, and,
   if appropriate,
(v) further substances selected from the group consisting of fillers, adhesion promoters, plasticizers, stabilizers, antioxidants, flame retardants, light stabilizers, and pigments.

The compositions used in the invention can be allowed to crosslink via irradiation with ultraviolet light (UV light), laser, or sunlight. It is preferable that the compositions of the invention are allowed to crosslink via UV light. Preferred UV light has wavelengths in the range from 200 to 400 nm. The UV light can by way of example be produced in xenon lamps, in low-pressure mercury lamps, in medium-pressure mercury lamps, or in high-pressure mercury lamps, or in excimer lamps. Another type of light suitable for the crosslinking process has a wavelength of from 400 to 600 nm, i.e. “halogen light”.

The irradiation wavelengths and irradiation times are wavelengths and times matched to the photopolymerization initiators used and to the compounds requiring polymerization.

Alongside high-energy radiation, heat, inclusive of heat supplied by means of infrared light, can be used. However, this type of heat is certainly not a requirement and it is preferable to avoid its use, in order to reduce energy cost.

In the case of one particularly preferred embodiment of the process of the invention, the exhaust gases from the conditioning oven are scrubbed through a water washer. This is preferably operated using water which is circulated and cooled. A large proportion of the organic components condenses here in the cold water and can be separated in the form of organic phase in liquid form by way of a coalescer. The process of the invention has the advantage that emissions are not transferred from the air into the water, but instead the amount of emissions is definitively reduced. The condensates separated can—if desired—be treated by known processes.

The process of the invention preferably injects oxygen-containing gas, with preference air, into the conditioning oven, and the preferred volume flow rate here is from 0.1 to 10 Nm³/h, given an oven volume of 2 m³. In the case of smaller ovens, the preferred volume flow rate should be reduced, and in the case of larger ovens it should be correspondingly increased. The volatile organic constituents produced during the conditioning procedure are thus removed. In industrial systems, the preferred volume flow rate of oxygen-containing gas is often achieved via leaks in the system.

A preferred throughput of air in the process of the invention is from 0.1 to 10 Nm³/h, given an oven volume of 2 m³, and the air here can involve air from the surrounding atmosphere, or else scrubbed exhaust air. The air in the process of the invention preferably comprises scrubbed exhaust air, in order to minimize the volume flow rate discharged into the environment, and thus to reduce the amount of emissions.

The expression “organic” in the context of the exhaust-gas components is intended for the purposes of this invention to include organosilicon components.

The major proportion of the volatile substances in the process of the invention comprises Dₓ-cyclic systems, where x=from 3 to 10, and also hexamethyldisiloxane, trimethylsilanol, and QM₄ and QM₃OH resins. The process of the invention can also produce decomposition products of peroxides. The nature and amount of volatile components produced in the process of the invention depend primarily on the constitution of the crosslinkable compositions used.

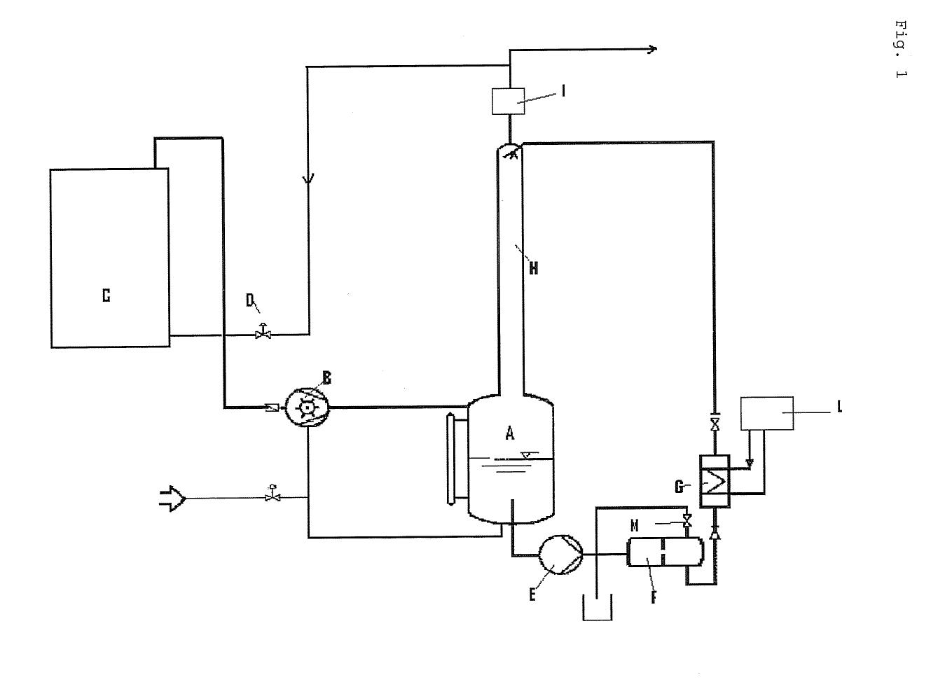

FIG. 1 illustrates one particularly preferred embodiment of the process of the invention: a liquid pump (B) has connection to a buffer container (A) for water. By virtue of the water circuit, the pump generates a subatmospheric pressure in the conditioning oven (C). The gas removed by suction from the oven (C) can comprise not only air but also organic constituents, and is mixed intimately, in the pump (B), with water, the temperature of which is preferably from 5 to 20° C., and a large proportion of the volatile compounds thus condenses. The previously cooled exhaust gas is passed through the container (A) and through the wash column (H) and an aerosol separator (I) to the exhaust-gas line. In the wash column (H), the exhaust-gas stream is again washed with water, the temperature of which is preferably from 3 to 10° C., thus further reducing contamination of the exhaust air.

If desired, stripping gas can be fed to the oven (C) by way of a control valve (D), in order to remove volatile constituents. To this end, the stripping gas is taken from the exhaust-gas line after the aerosol separator (I), and it is thus possible to minimize the exhaust-gas flow rate taken out of the building, and thus the amount of emissions. In the container (A), a mixture made of water and of an organic phase is produced, and the turbulent flow here brings about continuous mixing of the two liquid phases. A substream of this mixture is continuously passed by means of a pump (E) out of the container (A) and passed by way of a coalescer (F) which permits good separation of the aqueous phase and the organic phase. It is preferable that the aqueous phase is then cooled by way of a heat exchanger (G) with the aid of a cooler (L), and fed to the top of the column (H). The organic phase can, if necessary, be discharged from the coalescer (F) by way of the valve (M) and introduced into a recycling process. Although the liquid-circuit pump is operated with water, no waste water is produced. Water losses are preferably replaced with fresh water.

The process of the invention can be carried out continuously or batchwise.

The process of the invention has the advantage of being easy to carry out and very safe, since no superatmospheric pressure is produced under the conditions of the process, even in the event of ignition within the gas space.

The process of the invention also has the advantage that it is possible to operate with small air throughputs without reducing the level of safety. Heat transfer at the pressure of the invention is also comparable with that at atmospheric pressure.

The process of the invention moreover has the advantage that the amount of emissions is smaller by a factor of at least 10 than in the conventional processes of the prior art. Total energy consumption is markedly smaller, since there is only a small residual volume flow rate of material that requires heating. Furthermore, the volatile constituents, which represent a very valuable material, can be reclaimed. No deposits are now likely to occur in the exhaust-gas flue, since the prevailing temperatures in the wash column are generally lower than in the exhaust-gas flue. The system of the invention as represented by way of example in FIG. 1 can be constructed in compact fashion, and complicated installation work can therefore advantageously be avoided.

All the data relating to parts in the examples below relate to weight unless otherwise stated. Unless otherwise stated, the examples below are carried out at the pressure of the ambient atmosphere, i.e. at about 1000 hPa, and at room temperature, i.e. about 20° C., or at a temperature which results when the reactants are combined at room temperature, without additional heating or cooling. All of the viscosity data stated in the examples relate to a temperature of 25° C.

Shore A hardness is determined in accordance with DIN (German Industrial Standard) 53505 (issue of August 2000).

Compression set is determined to DIN ISO 815 B.

### EXAMPLE 1

A cubic rubber product with edge length about 10 cm is produced from a castable room-temperature-vulcanizing, addition-crosslinking two-component (RTV-2) silicone rubber composition (obtainable commercially from Wacker Chemie AG, Germany as ELASTOSIL® M 4601A+B) by using a laboratory stirrer to achieve homogeneous mixing of 9 parts of component A with 1 part of component B in a beaker. The mixture was cast to give a cube and the temperature sensor, which had been connected to a plotter, was positioned in the center of the cube. In order to remove air bubbles from the mixture, the mold to which the material had been charged was evacuated, prior to crosslinking, for about 10 minutes in a desiccator. Vulcanization took place at room temperature over a period of 15 hours at the pressure of the ambient atmosphere.

The resultant rubber product was heated to 200° C. at 100 hPa in a vacuum oven of about 100 liters capacity, and the heating rate of the rubber product was measured over a period of a number of hours by recording the temperature curves on a plotter. The leaks occurring in the system gave an air throughput of from 0.1 to 1 Nm³/h. The heating of another rubber product was measured for comparison, where the heating was carried out at the pressure of the ambient atmosphere, i.e. at about 1013 hPa (atmospheric pressure).

The heating rate of the two rubber products was found to be identical, and the temperature curves were almost identical (table 1).

TABLE 1

| Heating rate at | 100 mbar | 1013 mbar |
|---|---|---|
| t in min | T in ° C. | T in ° C. |
| 10 | 25 | 25 |
| 20 | 30 | 30 |
| 30 | 40 | 45 |
| 40 | 60 | 63 |
| 50 | 80 | 80 |
| 60 | 115 | 116 |
| 70 | 135 | 138 |
| 80 | 160 | 160 |
| 90 | 180 | 183 |
| 100 | 190 | 191 |
| 110 | 196 | 197 |
| 120 | 200 | 200 |
| 130 | 198 | 201 |
| 140 | 200 | 200 |

### EXAMPLE 2

In order to permit measurement of Shore A hardness in accordance with DIN, a square test foil of thickness 2 mm and edge length 15 cm was produced from an addition-crosslinking silicone rubber composition (obtainable commercially from Wacker Chemie AG, Germany as ELASTOSIL® LR 3003/40 A+B) that vulcanizes at 175° C., by using a laboratory stirrer to mix the two components A+B in a ratio of 1:1; the thickness of a square subregion of this foil was 6 mm. Said mixture was transferred to a metal mold of above dimensions and vulcanized in a laboratory press at 175° C. and at a pressure of 70 bar for a period of 5 minutes.

The resultant rubber product was then conditioned at a pressure of 100 hPa and 200° C. for a period of 4 hours in a vacuum oven of capacity about 100 liters. The leaks occurring in the system gave an air throughput of from 0.1 to 1 Nm³/h. For comparison, a test specimen was conditioned at atmospheric pressure under conditions that were otherwise identical.

The major proportion of the volatile substances comprises Dₓ-cyclic systems, where x=from 3 to 10, and also hexamethyldisiloxane, trimethylsilanol, and QM₄ and QM₃OH resins.

The resultant test specimens were used for determination both of Shore A hardness and of compression set. Table 2 shows the results.

### EXAMPLE 3

The procedure described in example 2 is repeated, except that the crosslinkable composition used comprises a heat-vulcanizing silicone rubber (obtainable commercially from Wacker Chemie AG, Germany as ELASTOSIL® LR 3003/60 A/B).

The major proportion of the volatile substances comprises Dₓ-cyclic systems, where x=from 3 to 10, and also hexamethyldisiloxane, trimethylsilanol, and QM₄ and QM₃OH resins.

Table 2 shows the results.

### EXAMPLE 4

The procedure described in example 2 is repeated, except that the crosslinkable composition used comprises a heat-vulcanizing silicone rubber (obtainable commercially from Wacker Chemie AG, Germany as ELASTOSIL® LR 3003/70 A+B).

The major proportion of the volatile substances comprises Dₓ-cyclic systems, where x=from 3 to 10, and also hexamethyldisiloxane, trimethylsilanol, and QM₄ and QM₃OH resins.

Table 2 shows the results.

### EXAMPLE 5

The procedure described in example 2 is repeated, except that the crosslinkable composition used comprises a heat-vulcanizing silicone rubber (obtainable commercially from Wacker Chemie AG, Germany as ELASTOSIL® LR 3003/80).

The major proportion of the volatile substances comprises Dₓ-cyclic systems, where x=from 3 to 10, and also hexamethyldisiloxane, trimethylsilanol, and QM₄ and QM₃OH resins.

Table 2 shows the results.

TABLE 2

| | |
|---|---|
| | Conditioned at |
| Conditioned | 1013 hPa as |
| at 100 hPa | comparative examples |

| | | Compression | | Compression |
|---|---|---|---|---|
| Example | Shore A | set | Shore A | set |
| 2 | 44 | 15% | 44 | 15% |
| 3 | 58 | 18% | 58 | 13% |
| 4 | 67 | 22% | 67 | 13% |
| 5 | 76 | 26% | 77 | 17% |

1.-9. (canceled)

10. A process for producing moldings made of silicone rubber via crosslinking of compositions based on organosilicon compounds and then conditioning of the resultant moldings, comprising conditioning the moldings in a conditioning oven at a pressure less than 150 hPa.

11. The process of claim 10, wherein conditioning is carried out at a pressure of from 10 to 150 hPa.

12. The process of claim 10, wherein conditioning is carried out at a temperature of from 20 to 350° C.

13. The process of claim 11, wherein conditioning is carried out at a temperature of from 20 to 350° C.

14. The process of claim 10, wherein conditioning is carried out in the presence of oxygen.

15. The process of claim 11, wherein conditioning is carried out in the presence of oxygen.

16. The process of claim 12, wherein conditioning is carried out in the presence of oxygen.

17. The process of claim 10, wherein conditioning is carried out in the presence of air.

18. The process of claim 10, wherein compositions based on organosilicon compounds selected from the group consisting of compositions crosslinkable via an addition reaction, peroxidically crosslinkable compositions, and radiation-crosslinkable compositions, are allowed to crosslink, and the resultant moldings are then conditioned at a pressure less than 150 hPa and at a temperature of from 20 to 350° C.

19. The process of claim 10, wherein exhaust gases from the conditioning oven are scrubbed with water in a water washer.

20. The process of claim 19, wherein water in the water washer comprises cold water at a temperature of from 3 to 20° C.

21. The process of claim 19, wherein an organic phase is formed and is separated from the water by a coalescer, and the water is recirculated.
